(19) United States
(12) Patent Application Publication
(10) Pub. No.: US 2015/0314757 A1
(43) Pub. Date: Nov. 5, 2015

(54) BUSBAR FOR AN ELECTRICAL DEVICE AND A WINDOW PANE INCLUDING THE SAME

(71) Applicants: AGC Automotive Americas R&D, Inc., Ypsilanti, MI (US); AGC Flat Glass North America, Inc., Alpharetta, GA (US)

(72) Inventors: Daniel D. Bennett, Tecumseh, MI (US); Al Kahwati, Nokomis, FL (US); William C. Schuch, Adrian, MI (US); John M. Seeley, Quincy, OH (US)

(73) Assignees: AGC Automotive Americas R&D, Inc., Ypsilanti, MI (US); AGC Flat Glass North America, Inc., Alpharetta, GA (US)

(21) Appl. No.: 14/701,346

(22) Filed: Apr. 30, 2015

Related U.S. Application Data
(60) Provisional application No. 61/986,534, filed on Apr. 30, 2014.

(51) Int. Cl. B60S 1/02; H01C 17/30; H01C 17/28; H05B 3/84; H01C 17/06

(52) U.S. Cl. CPC B60S 1/026; H05B 3/84; H01C 17/06; H01C 17/28; H01C 17/30; H05B 2203/013; H05B 2203/016; H05B 2203/017

(57) ABSTRACT

A window pane has a daylight opening and includes a substrate having a first surface. The window pane further includes an electrical device including a first busbar, a second busbar, and a gridline portion with each independently including a conductive material. The gridline portion has a first end operatively connected to and abutting the first busbar and a second end operatively connected to and abutting the second busbar. A gridline length is defined between the first and second ends of the gridline portion. The gridline portion is completely and directly disposed on the first surface along the gridline length. The first busbar and second busbar each independently includes a first layer of the conductive material disposed on the substrate. At least one of the first and the second busbars each independently includes a second layer of the conductive material disposed on the first layer.

### CROSS-REFERENCE TO RELATED APPLICATIONS

This application claims priority to and all the advantages of U.S. Provisional Patent Application Ser. No. 61/986,534, filed Apr. 30, 2014 which is expressly incorporated herein by reference in its entirety.

### FIELD OF THE DISCLOSURE

The present disclosure generally relates to a window pane having an electrical device and, more specifically, to busbars of the electrical device.

### BACKGROUND

A window pane for a vehicle may include an electrical device, such as a defroster or defogger, to clear condensation and thaw frost from the window pane. The electrical device typically includes conductive materials in or on the window pane. Electrical current is provided to the conductive materials of the electrical device by a pair of spaced busbars. The busbars must be suitable to conduct the amount of electrical current required for the electrical device to properly function. Typically, conventional busbars have a width of at least 12 mm to accommodate the amount of electrical current required for the electrical device.

A conductive braid (also known as a terminal braid) extending along each of the busbars is typically utilized in the electrical device for increasing the amount of the electrical current that is conducted through the electrical device. However, numerous solder joints are required to operatively connect the conductive braid to the busbar so that the conductive braid is in electrical communication with the busbar. This conductive braid, when utilized with the busbar, results in a production yield loss due to the occurrence of soldering defects and an increase in production time and cost due to the use of the numerous solder joints required to operatively connect the conductive braid to the busbar. Therefore, there remains a need to provide an improved busbar and window pane.

### SUMMARY OF THE DISCLOSURE

The present disclosure provides a window pane which has a daylight opening. The window pane includes a substrate having a first surface and a second surface opposite the first surface. The window pane further includes an electrical device including a first busbar, a second busbar, and a gridline portion with the first busbar, the second busbar, and the gridline portion each independently including a conductive material. The first busbar, the second busbar, and the gridline portion are in electrical communication with each other. The first busbar is disposed on the substrate. The second busbar is disposed on the substrate spaced from the first busbar. The gridline portion has a first end operatively connected to and abutting the first busbar and a second end operatively connected to and abutting the second busbar. A gridline length is defined between the first and second ends of the gridline portion. The gridline portion is completely and directly disposed on the first surface of the substrate along the gridline length. The first busbar and the second busbar each independently includes a first layer of the conductive material disposed on the substrate. At least one of the first and the second busbars each independently includes a second layer of the conductive material disposed on the first layer. The gridline portion includes one of the first layer of the conductive material or the second layer of the conductive material. The conductive material of the first layer and the second layer is either the same or different.

The present disclosure further provides a method for forming the window pane. The method includes the step of providing the substrate. The method also includes the step of disposing a first conductive composition on the substrate to form the first layer of the conductive material of the first busbar and the second busbar. The method further includes the step of disposing a second conductive composition, which is either the same as or different than the first conductive composition, on the first layer of the conductive material of at least one of the first busbar and the second busbar to form the second layer of the conductive material of at least one of the first busbar and the second busbar. The gridline portion is disposed on the substrate. The gridline portion is formed from the step of disposing the first conductive composition or from the step of disposing the second conductive composition.

### BRIEF DESCRIPTION OF THE DRAWINGS

Advantages of the present disclosure will be readily appreciated, as the same becomes better understood by reference to the following detailed description when considered in connection with the accompanying drawings wherein:

FIG. 1 is a perspective view of a vehicle including a window pane which includes an electrical device;

FIG. 2 is a plan view of a conventional window pane;

FIG. 3 is a plan view of one embodiment of the window pane;

FIG. 4 is a perspective view of another conventional window pane;

FIG. 5 is a perspective view of another embodiment of the window pane;

FIG. 6 is a perspective view of a vehicle including another embodiment of the window pane;

FIG. 7 is a perspective view of another embodiment of the window pane;

FIG. 8 is a perspective view of another embodiment of the window pane;

FIG. 9 is a cross-sectional schematic view of another embodiment of the window pane;

FIG. 10 is a cross-sectional schematic view of another embodiment of the window pane;

FIG. 11 is a cross-sectional schematic view of another embodiment of the window pane;

FIG. 12 is a cross-sectional schematic view of another embodiment of the window pane;

FIG. 13 is a cross-sectional schematic view of another embodiment of the window pane;

FIG. 14 is a cross-sectional schematic view of another embodiment of the window pane;

FIG. 15 is a cross-sectional schematic view of another embodiment of the window pane;

FIG. 16 is a cross-sectional schematic view of another embodiment of the window pane;

FIG. 17 is a cross-sectional schematic view of another embodiment of the window pane;

FIG. 18 is a cross-sectional schematic view of another embodiment of the window pane;

FIG. 19 is a cross-sectional schematic view of another embodiment of the window pane;

FIG. 20 is a cross-sectional schematic view of another embodiment of the window pane;

FIG. 21 is a cross-sectional schematic view of another embodiment of the window pane;

FIG. 22 is a cross-sectional schematic view of another embodiment of the window pane;

FIG. 23 is a cross-sectional schematic view of another embodiment of the window pane; and

FIG. 24 is a partially cut-away perspective view of another embodiment of the window pane.

### DETAILED DESCRIPTION OF THE DISCLOSURE

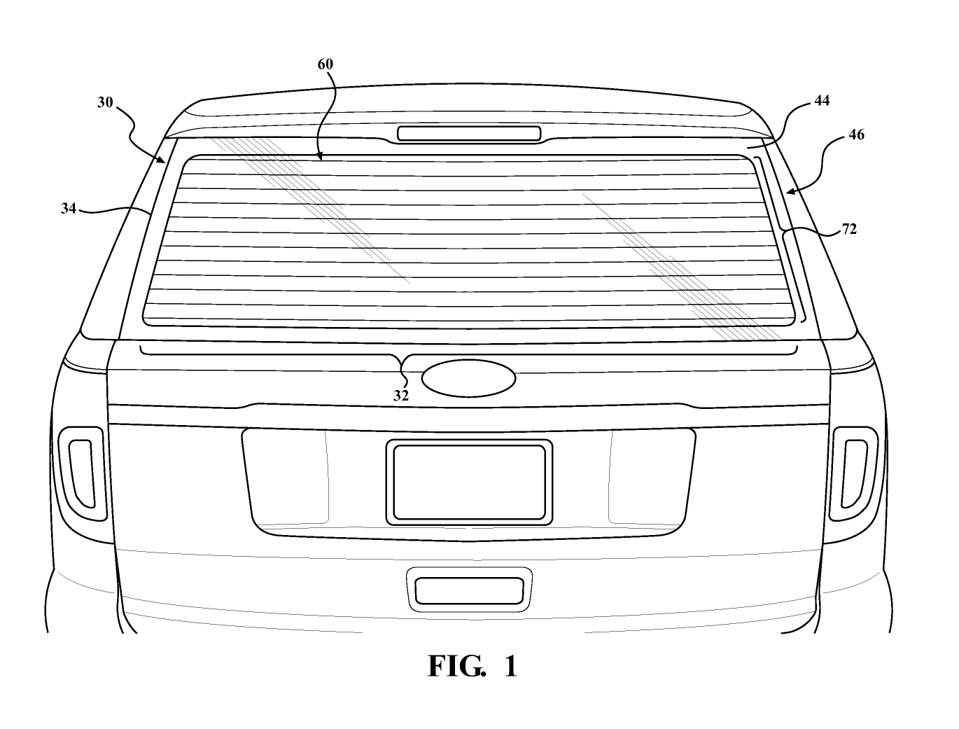

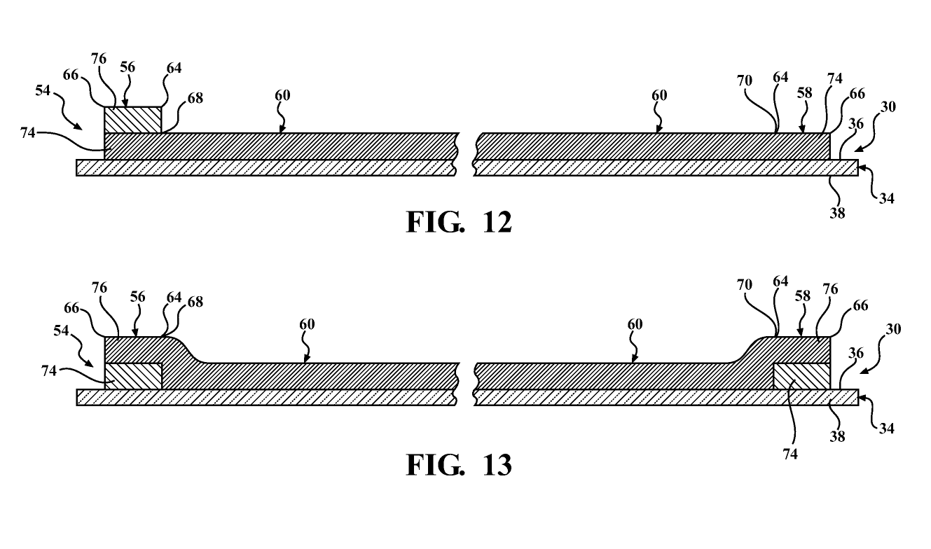

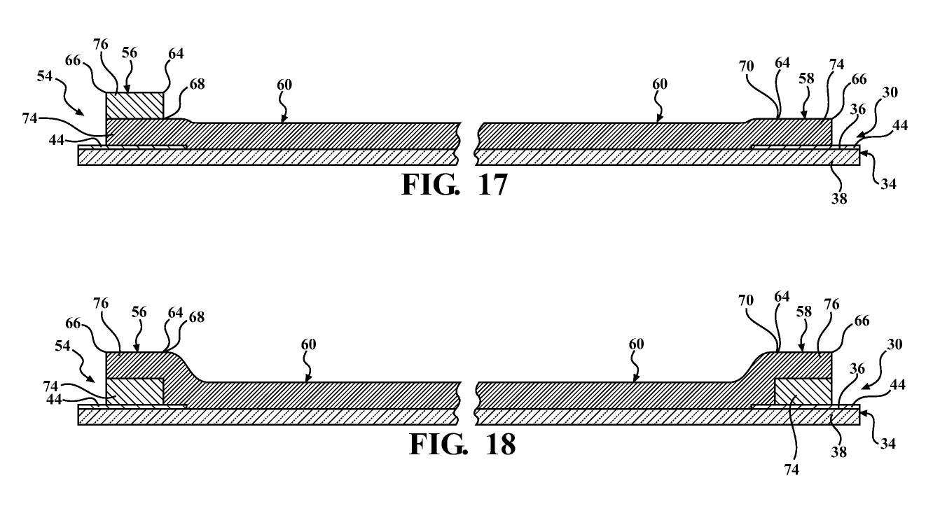

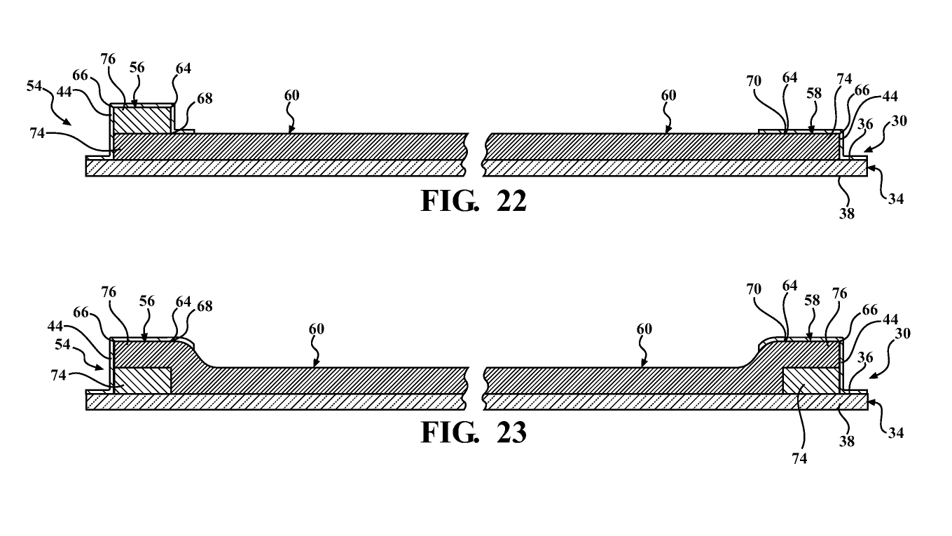

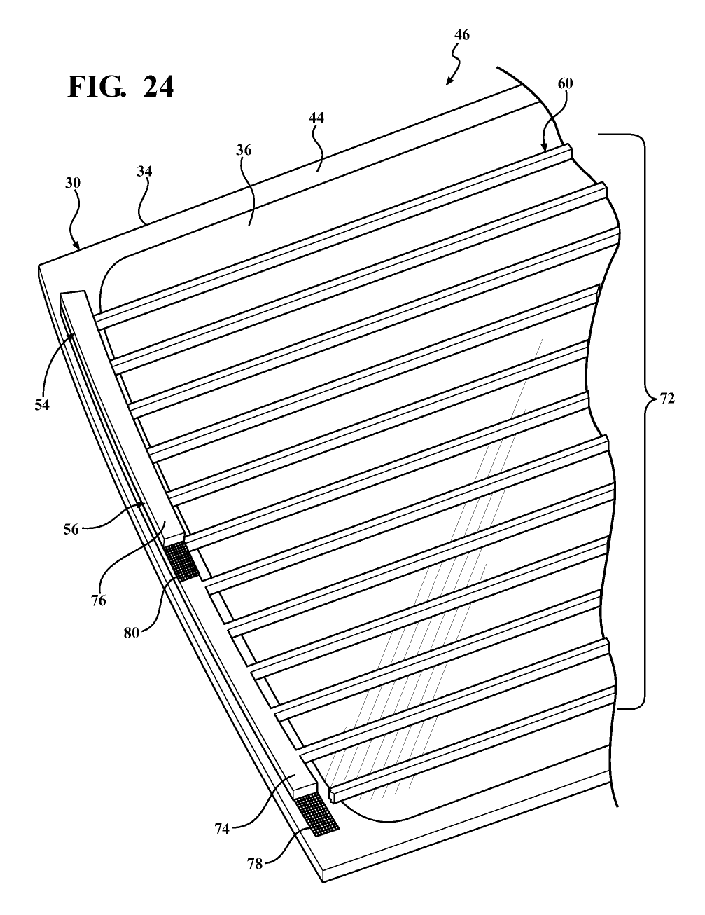

The present disclosure relates to a window pane 30. Referring to the Figures, wherein like numerals indicates like or corresponding parts throughout the views, suitable examples of the window pane 30 are generally shown in FIGS. 1, 3, and 5-24. In certain embodiments, the window pane 30 is for a vehicle. The window pane 30 has a daylight opening 32 which is typically optically transmissive to light. The window pane 30 includes a substrate 34 with the substrate 34 having a first surface 36 and a second surface 38 opposite the first surface 36.

The substrate 34 may include glass, plastic, polycarbonate, acrylic and combinations thereof. In one embodiment, the substrate 34 includes glass. Typically, the glass is further defined as automotive glass for a vehicle. The glass may also be further defined as soda-lime-silica based glass. However, it is to be appreciated that the glass may be any type of glass that is known in the art, e.g. borosilicate glass. It is to be appreciated that the substrate 34 may be coated, such as a coated glass. The substrate 34 has an edge disposed between the first surface 36 and the second surface 38 and extending along and around a periphery of the substrate 34. The first surface 36 of the substrate 34 has an area defined by the edge of the substrate 34. In various embodiments, the first surface 36 of the substrate 34 has a first side 40 and a second side 42 spaced from the first side 40.

As shown in FIGS. 1, 3, 5-8, and 14-24, in certain embodiments, the substrate 34 also has a ceramic frit layer 44 disposed on the first surface 36 of the substrate 34. Hereinafter, it is to be appreciated that in embodiments of the window pane 30 including the ceramic frit layer 44 of the substrate 34, any description referring to the substrate 34 may also refer to the ceramic frit layer 44 such that the disposition of a component on the substrate 34 may also include the disposition of the same component on the ceramic frit layer 44. Further, the same component may have one portion of itself disposed on the substrate 34 and a remaining portion disposed the ceramic frit layer 44.

Referring specifically to FIGS. 1, 3, 5, and 24, in one embodiment, the ceramic frit layer 44 of the substrate 34 is disposed at the periphery of the substrate 34 to define the daylight opening 32. Typically, in this embodiment, the ceramic frit layer 44 partially extends inward from the periphery of the substrate 34 toward an interior of the first surface 36. In various embodiments, the window pane 30 including the ceramic frit layer 44 disposed at the periphery of the substrate 34 is for a rear window 46 of a vehicle. Non-limiting examples of suitable vehicles having the rear window 46 include sedans, coupes, sport utility vehicles (SUVs), crossover SUVs, pickup trucks, and the like.

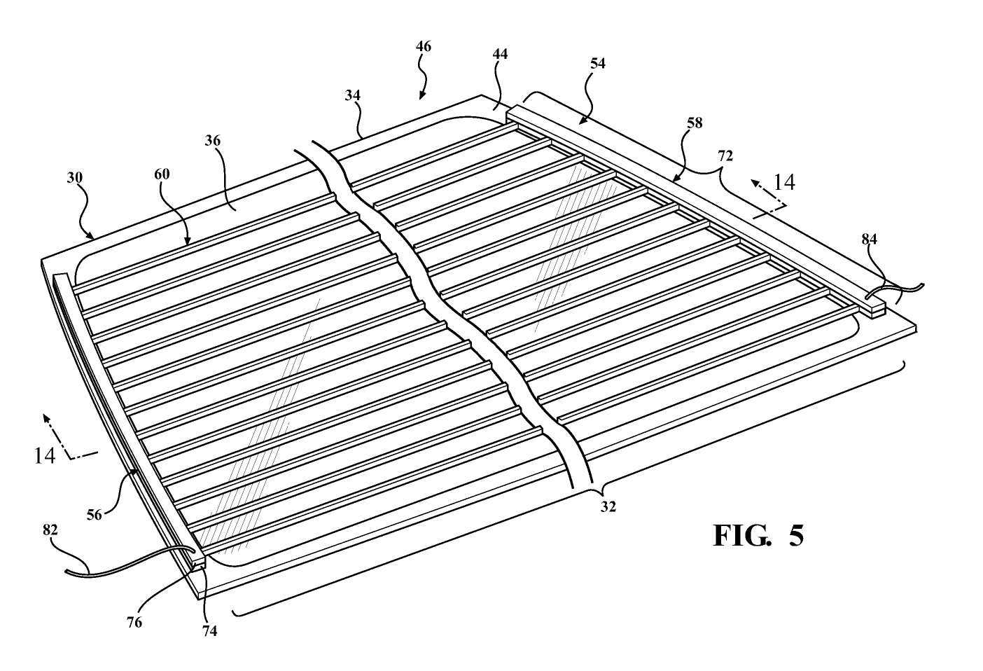

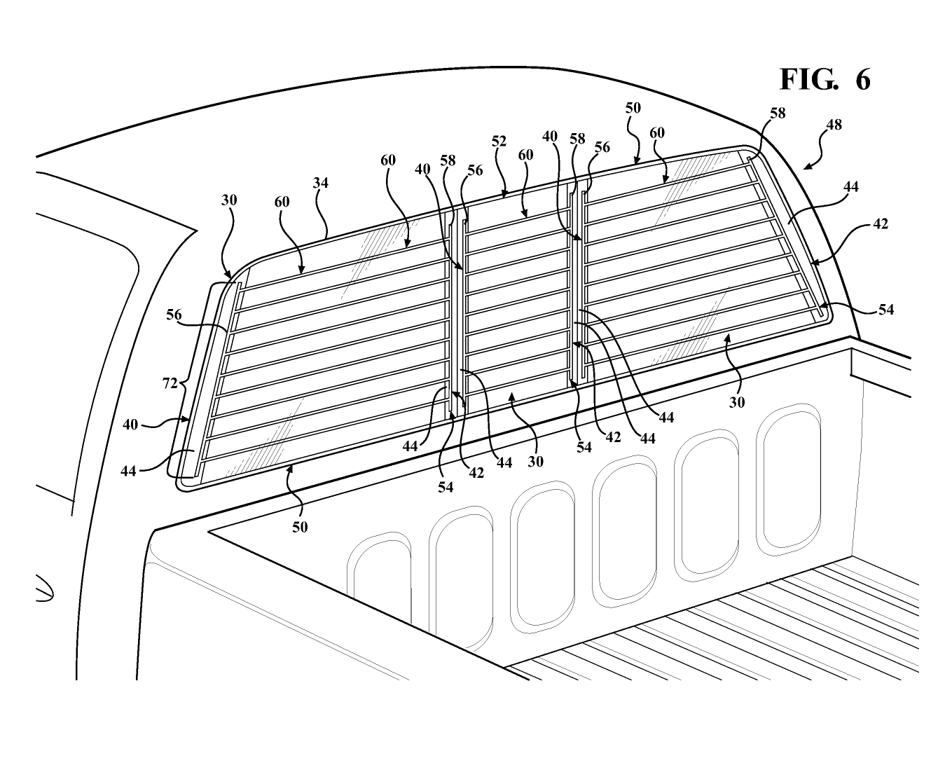

Referring specifically to FIGS. 6-8, in another embodiment, the ceramic frit layer 44 is disposed at the first side 40 of the substrate 34 and at the second side 42 of the substrate 34. Typically, in this embodiment, the ceramic frit layer 44 partially extends inward from each of the first and the second sides 40, 42 of the substrate 34 toward an interior of the first surface 36. In various embodiments, the window pane 30 including the ceramic frit layer 44 disposed at the first and the second sides 40, 42 of the substrate 34 is for a sliding window assembly 48 of a vehicle. Non-limiting examples of suitable vehicles having the sliding window assembly 48 include pickup trucks and the like.

The sliding window assembly 48 includes at least one fixed panel 50 and a sliding panel 52. Typically, the sliding window assembly 48 includes two fixed panels 50 and the sliding panel 52. The sliding panel 52 moves relative to the fixed panels 50 between an open position and a closed position. The sliding panel 52 typically moves horizontally relative to the fixed panels 50. However, it is to be appreciated that the siding panel 52 may move in any other suitable direction, such as vertically. In certain embodiments, the window pane 30 is utilized as both the fixed panels 50 and the sliding panel 52. However, it is to be appreciated that the window pane 30 may be utilized as only one of the fixed panels 50 or the sliding panel 52.

The window pane 30 further includes an electrical device 54. The electrical device 54 may be a heating grid, an antenna grid, or a combination thereof. The heating grid is also commonly referred to in the art as a defroster or a defogger. The electrical device 54 may be disposed about a region of the substrate 34. Typically, the electrical device 54 is disposed on the substrate 34. However, it is to be appreciated that the electrical device 54 may be disposed within the substrate 34; for example, the substrate 34 could be formed in a manner where the electrical device 54 is embedded within the substrate 34. In one embodiment, the electrical device 54 is disposed on and substantially about the substrate 34. The terminology “substantially about,” as utilized herein with reference to the electrical device 54, refers to the electrical device 54 being disposed across at least 50%, alternatively at least 60%, alternatively at least 70%, alternatively at least 80%, alternatively at least 90%, alternatively at least 95%, of the area the substrate 34. For example, when the electrical device 54 is a heating grid for the window pane 30, the heating grid is disposed on and substantially about the substrate 34.

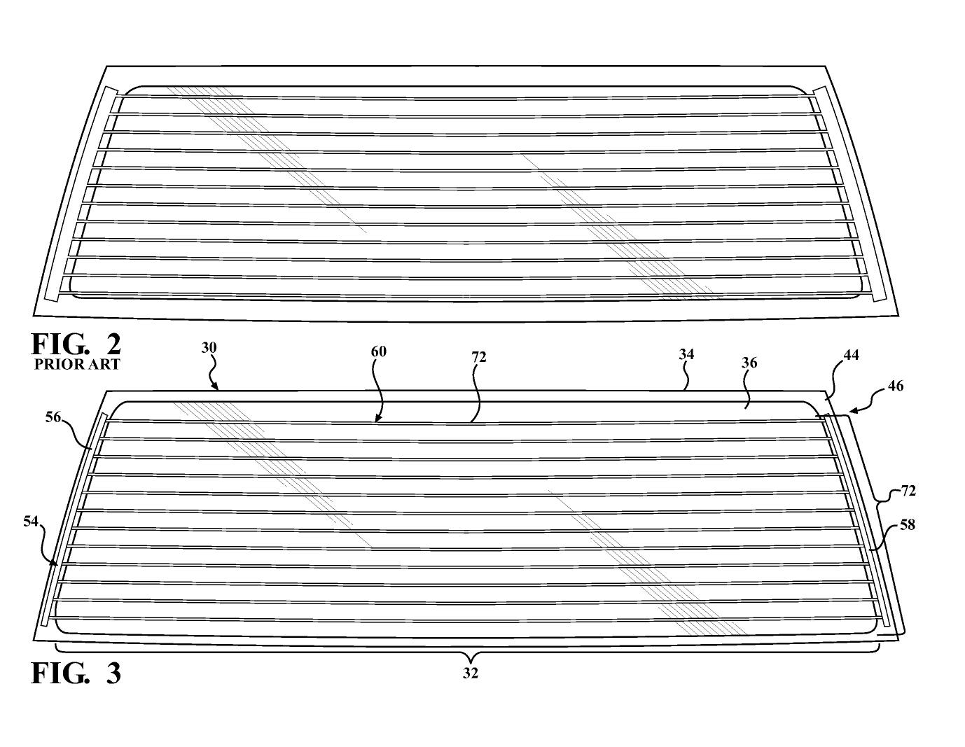

Referring to FIGS. 3, 5, 6-23, the electrical device 54 includes a first busbar 56, a second busbar 58, and a gridline portion 60 which are in electrical communication with each other. In certain embodiments, the first busbar 56 and the second busbar 58 conduct electrical current from an energy source to a ground. In various embodiments, the electrical device 54 is the heating grid. For example, when the electrical device 54 is a heating grid for automotive glass, the first busbar 56 receives the electrical current from an energy source in the vehicle (e.g. a battery or alternator) and conducts the electrical current to the gridline portion 60. Continuing with this example, the gridline portion 60 then conducts the electrical current to the second busbar 58 and the second busbar 58 then conducts the electrical current to the ground in the vehicle (e.g. to the battery). It is to be appreciated that the electrical current may alternatively flow from the second busbar 58 to the first busbar 56.

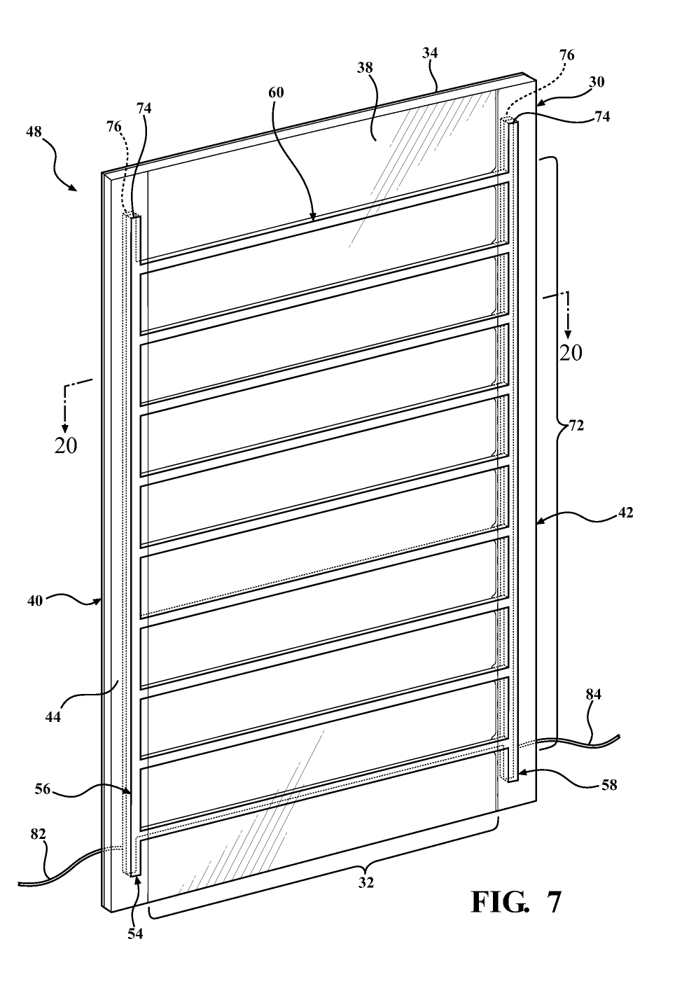

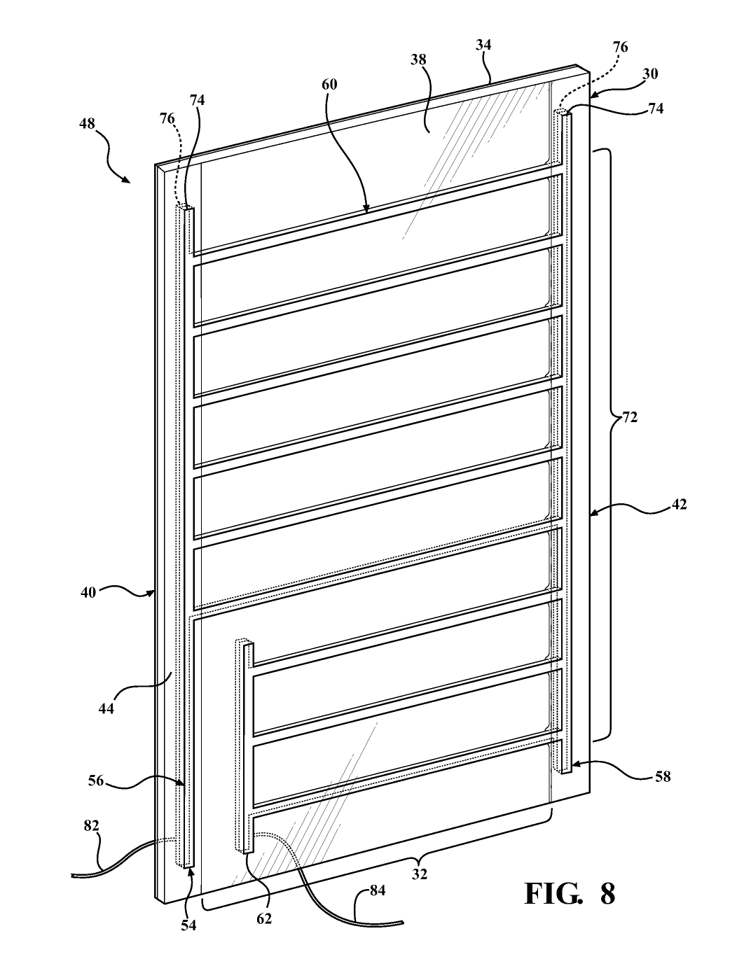

Referring specifically to FIG. 8, in certain embodiments, the electrical device 54 further includes a third busbar 62 in electrical communication with the first busbar 56, the second busbar 58, and the gridline portion 60. In one embodiment, the first busbar 56 and the third busbar 62 conduct electrical current from an energy source to a ground. For example, when the electrical device 54 is a heating grid for automotive glass, the first busbar 56 receives the electrical current from an energy source in the vehicle (e.g. a battery or alternator) and conducts the electrical current to the gridline portion 60. Continuing with this example, the gridline portion 60 then conducts the electrical current to the second busbar 58 and the second busbar 58 then conducts the electrical current back to the gridline portion 60. Still continuing with this example, the gridline portion 60 then conducts the electrical current to the third busbar 62 and the third busbar 62 then conducts the electrical current to the ground in the vehicle (e.g. to the battery). It is to be appreciated that the electrical current may alternatively flow from the third busbar 62 through the second busbar 38 to the first busbar 56.

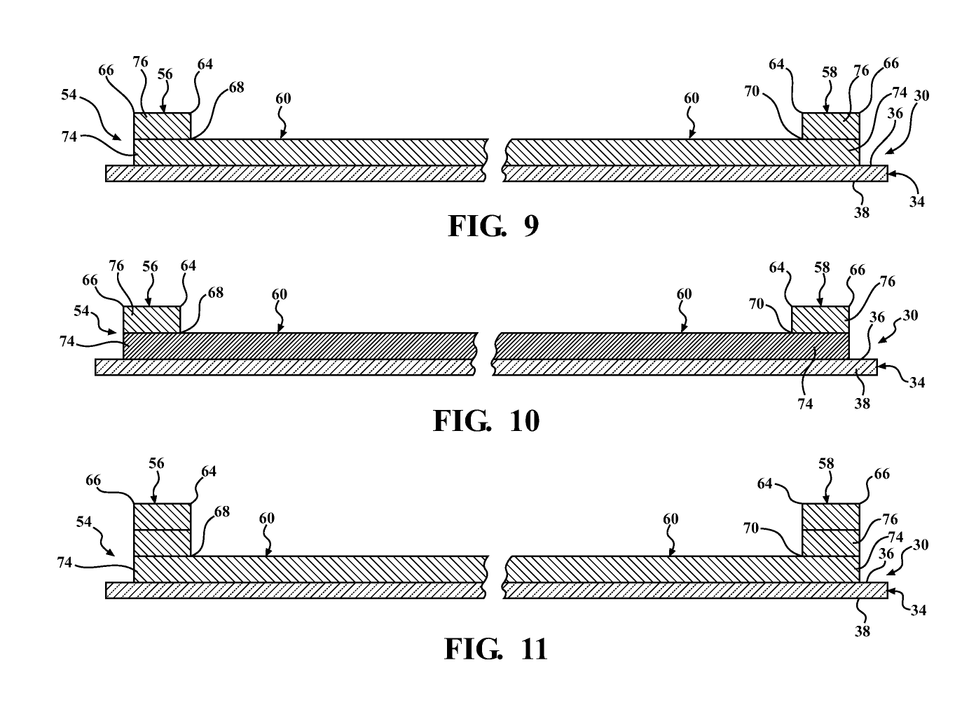

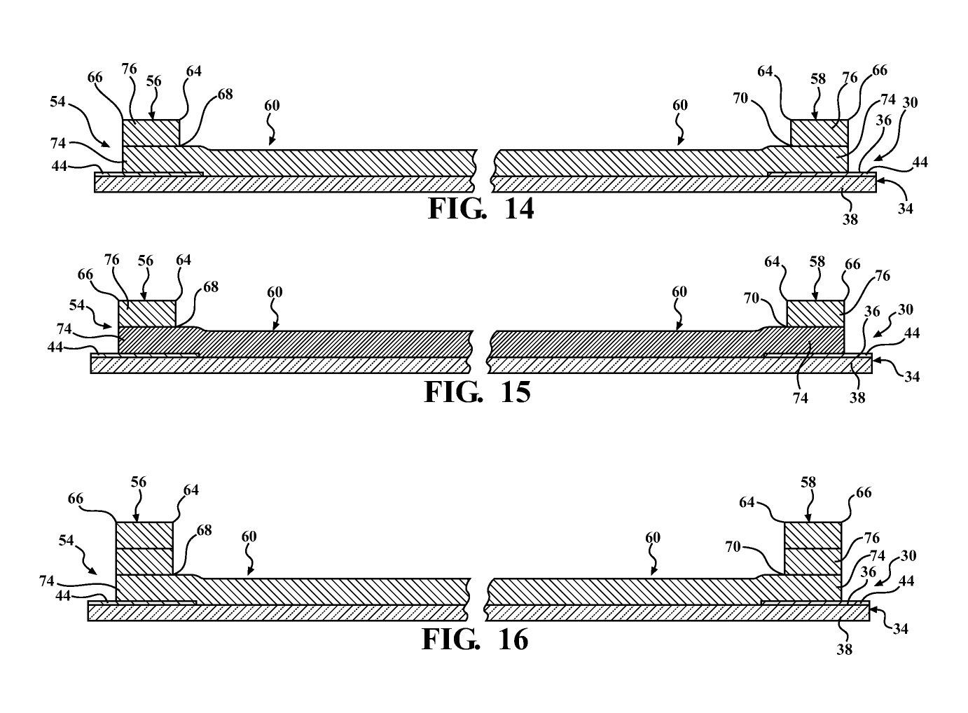

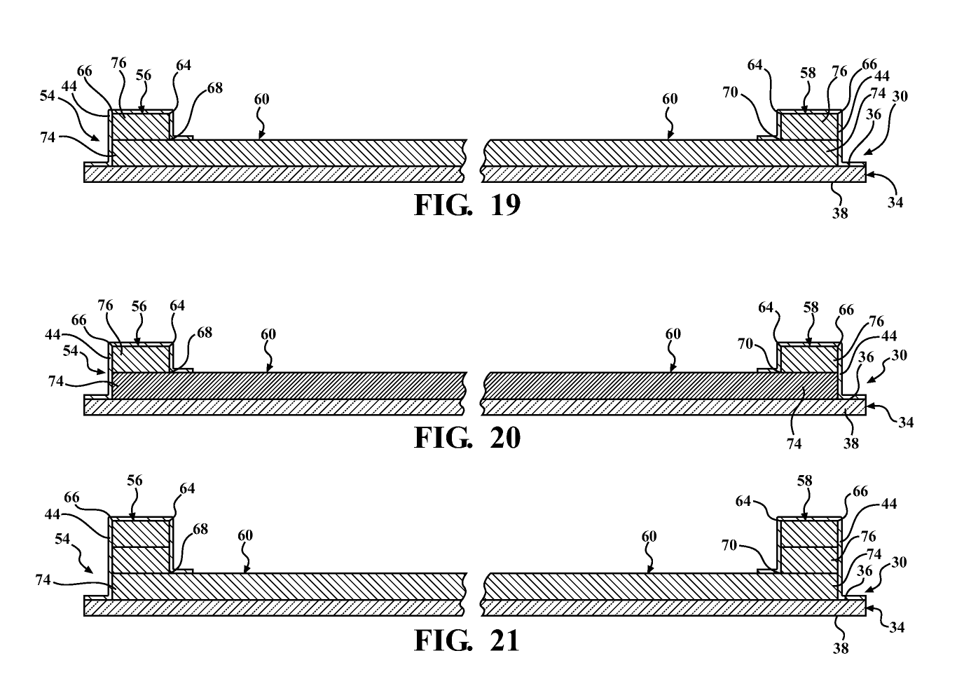

Referring back to FIGS. 3, 5, 6-23, the second busbar 58 is spaced from the first busbar 56, and the gridline portion 60 is disposed between the first busbar 56 and the second busbar 58. In certain embodiments, the first busbar 56 and the second busbar 58 are opposite each other with the gridline portion 60 disposed therebetween. However, it is to be appreciated that the first and second busbars 56, 58 do not have to be opposite one another. In one embodiment, such as an embodiment wherein the window pane 30 is the rear window 46 of a vehicle, the first busbar 56 and the second busbar 58 are disposed on the substrate 34 at the periphery with the second busbar 58 spaced from the first busbar 56. In another embodiment, such as an embodiment wherein the window pane 30 is for the sliding window assembly 48 of a vehicle, the first busbar 56 is disposed on the substrate 34 at the first side 40, and the second busbar 58 is disposed on the substrate 34 at the second side 42 with the second busbar 58 spaced from the first busbar 56. Referring specifically to FIGS. 9-13, in various embodiments, the first busbar 56 and the second busbar 58 are disposed directly on the substrate 34. Referring specifically to FIGS. 14-18, in certain embodiments, the first busbar 56 and the second busbar 58 are partially or fully disposed on the ceramic frit layer 44 of the substrate 34 and spaced from the substrate 34. Referring specifically to FIGS. 19-23, in other embodiments, the first busbar 56 and the second busbar 58 are disposed between the substrate 34 and the ceramic frit layer 44 of the substrate 34.

Referring specifically to FIG. 8, in embodiments including the third busbar 62, the third busbar 62 is disposed on the substrate 34. The third busbar 62 is typically disposed between the first busbar 56 and the second busbar 58. The third busbar 62 may be disposed at the periphery of the substrate 34, at the first side 40 of the substrate 34, or at the second side 42 of the substrate 34. In one embodiment, the third busbar 62 is disposed at the first side 40 of the substrate 34 with the first busbar 56. As with the first busbar 56 and the second busbar 58, the third busbar 62 may be partially or fully disposed on the ceramic frit layer 44 of the substrate 34 and spaced from the substrate 34, or disposed between the substrate 34 and the ceramic frit layer 44 of the substrate 34.

Referring to FIG. 3, 5, 7, 8, the first busbar 56 and the second busbar 58 each independently has a first edge 64 abutting the gridline portion 60 and a second edge 66 opposite the first edge 64 with the first edge 64 and the second edge 66 defining a busbar width W between the first edge 64 and the second edge 66. In certain embodiments, at least one of the first busbar 56 and the second busbar 58 has the busbar width W of less than 12, alternatively less than 11, alternatively less than 10, alternatively less than 9, or alternatively less than 7, millimeters (mm). In embodiments including the third busbar 62, the third busbar 62 has the busbar width W, as described immediately above.

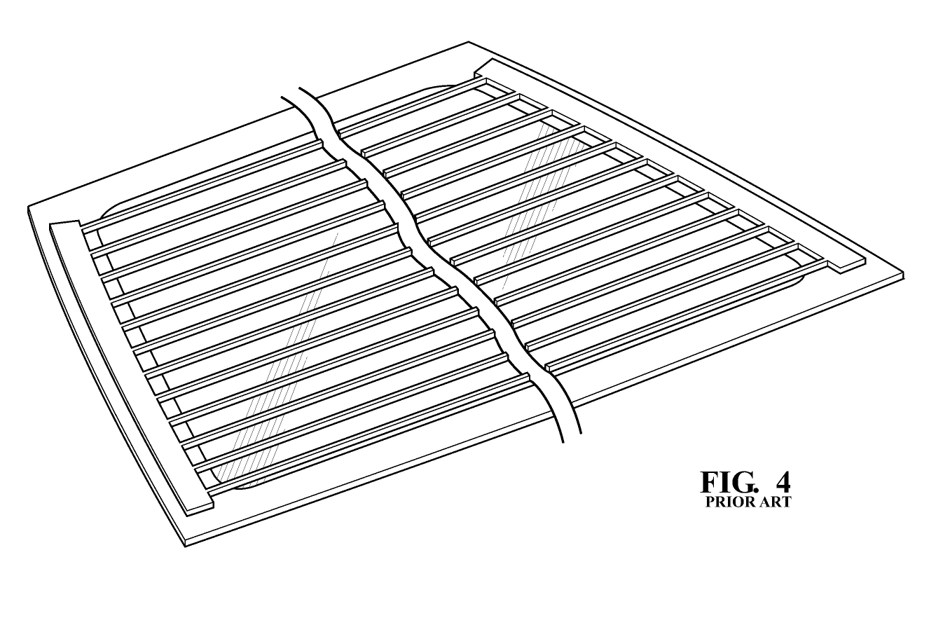

As described above, the daylight opening 32 is typically defined by the ceramic frit layer 44. To this end, an area of the daylight opening 32 may be defined on the substrate 34 by the ceramic frit layer 44. As will be described below, the ceramic frit layer 44 is typically affected by the busbar width W of the busbars. However, in embodiments not including the ceramic frit layer 44, the daylight opening 32 is also affected by the busbar width W of the busbars. In other words, the area of the daylight opening 32 can be maximized even where there is no ceramic frit layer 44 present, so long as the busbar width W is minimized. Typically, a decrease in the busbar width W of at least one of the first busbar 56 and the second busbar 58 results in a decrease in a width of the ceramic frit layer 44 and, therefore, a corresponding increase of the area of the daylight opening 32. For example, the window panes 30 shown in FIGS. 3 and 5 have an increase of the area of the daylight opening 32 as compared to conventional window panes shown in FIGS. 2 and 4. The terminology “area of the daylight opening,” as utilized herein with reference to the window pane 30, refers to the amount of surface area of the substrate 34 which permits light to pass-through the substrate 34. An increase in the area of the daylight opening 32 typically results in an improved appearance of the window pane 30 and improved driver feel/perception. In certain embodiments, the window pane 30 has an increase in the area of the daylight opening 32 of at least 1%, alternatively at least 2%, or alternatively at least 3% as compared to the area of the daylight opening of conventional window panes. Although such percentages may appear low, in the relevant industry, these percentages are significant, particularly when dealing with improvements in the are of the daylight opening 32.

Referring back to FIGS. 1, 3, 5-8, and 14-24, the gridline portion 60 is typically disposed on the substrate 34 in the daylight opening 32. Referring specifically to FIGS. 9-13, the gridline portion 60 may be disposed directly on the substrate 34. Referring specifically to FIGS. 14-18, the gridline portion 60 may be partially disposed on the ceramic frit layer 44 of the substrate 34. Referring specifically to FIGS. 19-23, the gridline portion 60 may be partially disposed between the substrate 34 and the ceramic frit layer 44 of the substrate 34. The gridline portion 60 has a first end 68 operatively connected to and abutting the first busbar 56 and a second end 70 operatively connected to and abutting the second busbar 58. The gridline portion 60 can have any configuration known in the art for electrical devices. Typically, the gridline portion 60 includes one or more heating elements 72 with each heating element 72 extending from the first end 68 of the gridline portion 60 to the second end 70 of the gridline portion 60. Typically, the heating elements 72 define one or more gaps between adjacent heating elements 72 of the gridline portion 60. The heating elements 72 may have a linear configuration, a curved configuration, a crosshatch configuration, a zigzag configuration, a sinusoidal configuration, or combinations thereof. In various embodiments, the gridline portion 60 includes two or more heating elements 72. In certain embodiments, where there are not two or more heating elements 72, the gridline portion 60 is free of the gaps described above.

A gridline length L is defined between the first and the second ends 68, 70 of the gridline portion 60. The gridline portion 60 is completely and directly disposed on the first surface 36 of the substrate 34 along the gridline length L. It is to be appreciated that in embodiments wherein the substrate 34 has the ceramic frit layer 44 and the gridline portion 60 is partially disposed on the ceramic frit layer 44, the gridline portion 60 is completely and directly disposed on both the first surface 36 of the substrate 34 and the ceramic frit layer 44 along the gridline length L.

The first busbar 56, the second busbar 58, and the gridline portion 60 each independently include a conductive material. The conductive material of the first busbar 56, the second busbar 58, and the gridline portion 60 each independently has a resistivity, which can be the same or different. The resistivity of the conductive material typically results in a generation of heat when electrical current is conducted there through. This generation of heat is typically utilized to clear condensation and thaw frost from the window pane 30. In certain embodiments, the resistivity of the conductive material of the first busbar 56 and the second busbar 58 is each independently less than the resistivity of the conductive material of the gridline portion 60. In various embodiments, the resistivity of the conductive material of the first busbar 56 or the second busbar 58 is less than the resistivity of the conductive material of the gridline portion 60. However, the resistivity of at least one of the first and second busbars 24, 26 does not have to be less than the resistivity of the gridline portion 60. In embodiments including the third busbar 62, the third busbar 62 also includes the conductive material as described immediately above.

Referring to FIGS. 5 and 7-24, the first busbar 56, the second busbar 58, and the gridline portion 60 each independently include one or more layers of the conductive material. In certain embodiments, at least one of the first and the second busbars 56, 58 includes, consists essentially of, or consists of, two layers of the conductive material. In embodiments including the third busbar 62, the third busbar 62 includes one or more layers of the conductive material. In certain embodiments, the third busbar 62 includes, consists essentially of, or consists of, two layers of the conductive material. In other embodiments, at least one of the first, the second, and the third busbars 56, 58, 62 includes, consists essentially of, or consists of, three, four, five, six, seven, eight, nine, or ten, layers of the conductive material.

Typically, by increasing the number of layers of the conductive material, the busbar width W of at least one of the first, the second, and the third busbars 56, 58, 62 which includes the conductive material is reduced while maintaining the same amount of electrical current that is conducted by the conductive material and thus conducted by at least one of the first, the second, and the third busbars 56, 58, 62. Said differently, by increasing the number of layers of the conductive material and reducing the busbar width W, the cross-sectional area of the conductive material may remain the same, which typically maintains the same amount of electrical current that is conducted by at least one of the first, the second, and the third busbars 56, 58, 62. In other words, by increasing the number of layers of the conductive material and reducing the busbar width W, the current density of the busbars remains the same. As such, the busbar width W of at least one of the first, the second, and the third busbars 56, 58, 62 including multiple layers of the conductive material typically results in an increase of the area of the daylight opening 32 while maintaining the same amount of electrical current that is conducted by at least one of the first, the second, and the third busbars 56, 58, 62. In embodiments including the ceramic frit layer 44, the busbar width W typically results in a decrease of the width of the ceramic frit layer 44 and a corresponding increase of the area of the daylight opening 32 while maintaining the same amount of electrical current that is conducted by at least one of the first, the second, and the third busbars 56, 58, 62.

Further, providing the conductive material in multiple layers allows for a thickness of the conductive material at the busbars 56, 58, 62 to vary relative to a thickness of the gridline portion 60. As such, the thickness of the busbars 56, 58, 62 may be greater than the thickness of the gridline portion 60. If the gridline portion 60 becomes too thick, the substrate 34 may be damaged due to excessive heat. Also, as the thickness of the gridline portion 60 increases, an increase in energy consumption may result. Further, a busbar only including a single layer of an increased amount of conductive material may delaminate from the substrate due to inadequate drying caused by the inability of the heat to thoroughly penetrate the conductive material to evaporate moisture as compared to a busbar of the same thickness including multiple layers of conductive material.

The first busbar 56 and the second busbar 58 each independently includes a first layer 74 of the conductive material disposed on the substrate 34. In certain embodiments, the gridline portion 60 includes the first layer 74 of the conductive material disposed on the substrate 34. In further embodiments, the first layer 74 of the conductive material of the first busbar 56, the second busbar 58, and the gridline portion 60 is a single and homogenous layer extending along the substrate 34. It is to be appreciated that the single and homogenous layer may include voids in the layer, yet still be homogenous. The terminology “homogenous,” as utilized herein with reference to the conductive material, refers to the composition of the conductive material and not the configuration of the first busbar 56, the second busbar 58, and the gridline portion 60 which include the conductive material. In embodiments including the third busbar 62, the third busbar 62 includes the first layer 74 of the conductive material. Further, in embodiments including the third busbar 62, the first layer 74 of the conductive material of the first busbar 56, the second busbar 58, the third busbar 62, and the gridline portion 60 may be a single and homogenous layer extending along the substrate 34, as described above.

At least one of the first and the second busbars 56, 58 each independently includes a second layer 76 of the conductive material disposed on the first layer 74. In certain embodiments, the gridline portion 60 includes the second layer 76 of the conductive material disposed on the substrate 34. In embodiments including the third busbar 62, the third busbar 62 includes the second layer 76 of the conductive material. As described above, in certain embodiments, at least one of the first, the second, and the third busbars 56, 58, 62 includes additional layers of the conductive material. As also described above, by utilizing multiple layers of the conductive material for the busbars, the busbars may have a reduced busbar width W and an increased amount of electrical current that can be conducted through the busbars. It is to be appreciated that each of the first layer 74 and the second layer 76 of the conductive material for each of the first busbar 56, the second busbar 58, the third busbar 62, and the gridline portion 60 may be the same or different.

In certain embodiments, the first layer 74 of the conductive material and the second layer 76 of the conductive material each independently has a dry film thickness T of no greater than 20, alternatively no greater than 15, or alternatively no greater than 12, μm. In other embodiments, the first layer 74 of the conductive material and the second layer 76 of the conductive material each independently has a dry film thickness T of from 1 to 20, alternatively 3 to 15, or alternatively 6 to 12, μm.

In various embodiments, the conductive material has a total dry film thickness of no greater than 60, no greater than 45, or alternatively no greater than 35, μm. In further embodiments, the conductive material has a total dry film thickness of from 1 to 60, alternatively from 3 to 45, or alternatively from 6 to 35, μm.

The first layer 74 of the conductive material and the second layer 76 of the conductive material may include silver as the conductive material. Further, the conductive material is typically formed from a conductive composition including silver. However, it is to be appreciated the conductive material may include other conductive metals such as carbon in certain forms (e.g. graphite), copper, gold, aluminum, zinc, brass, bronze, conductive oxides, and combinations thereof. Examples of suitable conductive oxides include transition metal oxides, such as indium tin oxide (ITO) and fluorine tin oxide. The conductive material may include nonconductive materials and still be conductive for the purposes of this window pane 30. Examples of such nonconductive materials include, but are not limited to, carbon in certain forms (e.g. carbon black) and silica based oxides.

The conductive material may be provided in the form of a film or a coating. Typically, the conductive material is disposed on the substrate 34, the ceramic frit layer 44, or another layer of the conductive material via printing, brushing, layering, dipping, spraying, or any other method known in the art for disposing the conductive material. In certain embodiments, the conductive material is in the form of a coating formed from a silver paste which is printed on the substrate 34.

In certain embodiments, the silver paste includes silver, a carrier, and additives. The silver paste may also include a binder. The carrier of the silver paste may include pine oil. In one embodiment, a first silver paste has a resistivity of from 1.0 to 1.4 ohm per foot (Ω/ft). In another embodiment, a second silver paste has a resistivity of from 2.5 to 4.5 Ω/ft. In still another embodiment, a third silver paste may have a resistivity of from 4.0 to 8.0 Ω/ft. Commercial examples of suitable silver pastes include DuPont 9903B, DuPont 9912B, DuPont 9915B, Johnson-Matthey A6174AP, and Johnson-Matthey A6175AP. DuPont 9903B has of from 77.8 to 79.6 percent silver by weight, a viscosity of from 40 to 50 Pa-s, a density 3.8 g/cc, and a nominal resistivity of 1.2 Ω/ft. DuPont 9912 has from 68.4 to 70.3 percent silver by weight, a viscosity of from 25 to 35 Pa-s, a density of 3.0 g/cc, and a nominal resistivity of 3.9 Ω/ft. DuPont 9915 has from 57.1 to 59.1 percent silver by weight, a viscosity of from 25 to 35 Pa-s, a density of 2.2 g/cc, and a nominal resistivity of 6.6 Ω/ft. Johnson-Matthey A6174AP has from 77.0 to 79.0 percent silver by weight, a viscosity of from 25 to 30 Pa-s, a density of 3.76 g/cc, and a nominal resistivity of 0.85 Ω/ft. Johnson-Matthey A6175AP has from 63.5 to 65.5 percent silver by weight, a viscosity of from 25 to 30 Pa-s, a density of 2.55 g/cc, and a nominal resistivity of 2.0 Ω/ft.

In certain embodiments, the first silver paste may include DuPont 9903B in an amount of from 45 to 75, alternatively 50 to 70, or alternatively 55 to 65, parts by weight, and DuPont 9912B in an amount of from 25 to 55, alternatively 30 to 50, or alternatively 35 to 45, parts by weight, each based on 100 parts by weight of the first silver paste. In various embodiments, the second silver paste may include DuPont 9903B in an amount of from 70 to 100, alternatively 75 to 100, or alternatively 80 to 100, parts by weight, and DuPont 9912B in an amount of from 0 to 30, alternatively 0 to 25, or alternatively 0 to 20, parts by weight, each based on 100 parts by weight of the second silver paste.

In embodiments where the conductive material is formed from the silver paste, components of the silver paste may result in delamination of the conductive material having multiple layers. More specifically, in embodiments where the silver paste includes pine oil, the pine oil may cause delamination of the conductive material from the substrate 34, the ceramic frit layer 44, or another layer of the conductive material. As will be described in greater detail below, this delamination can be minimized by drying each layer of the conductive material prior to the disposing of additional layers of the conductive material. In certain embodiments, to minimize the risk of this delamination, each layer of the conductive material has a dry film thickness T of no greater than 20 μm, and the conductive material has a total dry film thickness of no greater than 60 μm.

Referring specifically to FIG. 24, a mesh screen may be disposed on the substrate 34 (and, when utilized, on the layer(s) of the conductive material) prior to disposing each layer of the conductive material thereon. A first mesh screen 78 includes pores and has a pore size number of from 40 to 100, alternatively 50 to 90, or alternatively 60 to 80, threads/inch. A second mesh screen 80 includes pores and has a pore size number of from 130 to 250, alternatively 180 to 220, or alternatively 190 to 210, threads/inch. Typically, the pore size of the mesh screen has an impact on the generation of heat resulting from the conductive material such that an increase in the size of the pores of the mesh screen (i.e., a decrease in the pore size number) increases the generation of heat of the conductive material, and vice versa. It is to be appreciated that the mesh screen may be disposed with the layer of the conductive material after disposition of the conductive composition.

Referring specifically to FIGS. 10, 12, 15, 17, 20, and 22, in certain embodiments, the first layer 74 of the conductive material is formed from the first silver paste with the first layer 74 having a first resistivity, and the second layer 76 of the conductive material is formed from the second silver paste with the second layer 76 having a second resistivity which is lower than the first resistivity such that the conductive material of the first layer 74 and the second layer 76 are different. As such, in these embodiments, the first layer 74 of the conductive material of each of the first busbar 56, the second busbar 58, and the gridline portion 60 has the first resistivity (i.e., a higher resistivity), and the second layer 76 of the conductive material of each of the first busbar 56 and the second busbar 58 has the second resistivity (i.e., a lower resistivity). To this end, and due to the lower resistivity of the second layer 76 of the conductive material as compared to the resistivity of the first layer 74, the conductive material of each of the first busbar 56 and the second busbar 58 has a resistivity lower than the resistivity of the conductive material of the gridline portion 60. In certain embodiments, the first layer 74 of the conductive material has a resistivity of from 2.4 to 5.1 Ω-ft and the second layer 76 of the conductive material has a resistivity of from 1.0 to 3.9 Ω-ft with the resistivity of the first layer 74 of the conductive material being greater than the resistivity of the second layer 76 of the conductive material. In embodiments including the third busbar 62, the third busbar 62 may include the first layer 74 and the second layer 76, as described immediately above.

Referring specifically to FIGS. 9, 11, 14, 16, 19, and 21, in various embodiments, both the first layer 74 and the second layer 76 of the conductive material are formed from the second silver paste and have the second resistivity such that the conductive material of the first layer 74 and the second layer 76 are the same. As such, in these embodiments, the first layer 74 of the conductive material of each of the first busbar 56, the second busbar 58, and the gridline portion 60 has the second resistivity, and the second layer 76 of the conductive material of each of the first busbar 56 and the second busbar 58 also has the second resistivity. These embodiments having the lower resistivity of the gridline portion 60 may be utilized for a window pane 30 having a smaller surface area because a lower generation of heat is required to clear condensation and thaw frost from this window pane 30. In certain embodiments, the first layer 74 of the conductive material and the second layer 76 of the conductive material each independently has a resistivity of from 1.0 to 3.9 Ω/ft. In embodiments including the third busbar 62, the third busbar 62 may include the first layer 74 and the second layer 76, as described immediately above.

Referring specifically to FIGS. 13, 18, and 23, in other embodiments, the first layer 74 of the conductive material is formed from the second silver paste with the first layer 74 having the second resistivity, and the second layer 76 of the conductive material is formed from the first silver paste with the second layer 76 having the first resistivity which is higher than the second resistivity such that the conductive material of the first layer 74 and the second layer 76 are different. As such, in these embodiments, the first layer 74 of the conductive material of each of the first busbar 56 and the second busbar 58 has the second resistivity (i.e., a lower resistivity), and the second layer 76 of the conductive material of each of the first busbar 56, the second busbar 58, and the gridline portion 60 has the first resistivity (i.e., a higher resistivity). To this end, and due to the higher resistivity of the second layer 76 of the conductive material as compared to the resistivity of the first layer 74, the conductive material of each of the first busbar 56 and the second busbar 58 has a resistivity lower than the resistivity of the conductive material of the gridline portion 60. In certain embodiments, the first layer 74 of the conductive material has a resistivity of from 1.0 to 3.9 Ω/ft and the second layer 76 of the conductive material has a resistivity of from 2.4 to 5.1 Ω/ft with the resistivity of the second layer 76 of the conductive material being greater than the resistivity of the first layer 74 of the conductive material. In embodiments including the third busbar 62, the third busbar 62 may include the first layer 74 and the second layer 76, as described immediately above.

Referring back to the ceramic frit layer 44 described above, the ceramic frit layer 44 may be formed from a ceramic composition which includes ceramic and at least one carrier. An example of a suitable ceramic composition includes Ferro AD3402A, which contains bismuth, nickel iron chromite, copper chromite, quartz silicate, silicon, and solvents. It is to be appreciated that the ceramic frit layer 44 can be applied to the substrate 34 in a separate step as a separate layer from the substrate 34, or that the substrate 34 can be originally provided having the ceramic frit layer 44 already integral thereon. The carrier of the ceramic composition may include pine oil. In embodiments where the carrier of the ceramic composition includes pine oil, the pine oil may cause delamination of the conductive material from the substrate 34. As will be described in greater detail below, this delamination can be minimized by drying the ceramic frit layer 44 formed from the ceramic composition prior to disposing the conductive material thereon.

Referring specifically to FIGS. 5, 7, and 8, the window pane 30 may also include lead wires operatively connected to and in electrical communication with the electrical device 86. More specifically, in certain embodiments, a first lead wire 86 is operatively connected to and in electrical communication with first busbar 56, and a second lead wire 88 is operatively connected to and in electrical communication with the second busbar 58. The first lead wire 86 (or alternatively the second lead wire 88) is typically operatively connected to and in electrical communication with the energy source described above. The second lead wire 88 (or alternatively the first lead wire 86) is typically operatively connected to and in electrical communication with the ground of the vehicle as also describe above. In embodiments including the third busbar 62, the first lead wire 86 or the second lead wire 88 may be operatively connected to and in electrical communication with the third busbar 62. In embodiments wherein the first busbar 56 and the third busbar 62 are both disposed at the first side 40 of the substrate 34, the first lead wire 86 or the second lead wire 88 may be operatively connected to and in electrical communication with the first busbar 56 and the other of first lead wire 86 or the second lead wire 88 may be operatively connected to and in electrical communication with the third busbar 62 such that the both lead wires 86, 88 are disposed adjacent to the first side 40 of the substrate 34.

In certain embodiments, the conductive material is free of solder between the first layer 74 of the conductive material and the second layer 76 of the conductive material. It is to be appreciated that the conductive material including solder joints disposed on the conductive material is still free of solder between the first layer 74 of the conductive material and the second layer 76 of the conductive material.

In certain embodiments, the electrical device 54 includes no more than two solder joints. Typically, in embodiments including two solder joints, one of the solder joints operatively connects the first lead wire 54 to the electrical device 54 and the other solder joint operatively connects the second lead wire 56 to the electrical device 54. In other words, the electrical device 54 may have no solder joints whatsoever other than the solder joints to operatively connect the first lead wire 86 and the second lead wire 88 to the electrical device 54.

In various embodiments, the electrical device 54 is free of a conductive braid. Conductive braids may result in a production yield loss due to the occurrence of soldering defects and an increase in production time and cost due to the use of additional solder joints.

The present disclosure also relates to a method of forming the window pane 30. As described above, an electrical device 54 includes the first busbar 56, the second busbar 58, and the gridline portion 60 with the first busbar 56, the second busbar 58, and the gridline portion 60 in electrical communication with each other and each independently including the conductive material. In certain embodiments, the first and the second busbars 56, 58 are disposed on at least one of the substrate 34 and the ceramic frit layer 44 with the gridline portion 60 disposed on at least one of the substrate 34 and the ceramic frit layer 44. In various embodiments, as described above, the electrical device 54 further includes the first mesh screen 78 and the second mesh screen 80

Referring back to FIGS. 1, 3, and 5-24, the method of forming the window pane 30 includes the step of providing the substrate 34. The method may further includes the step of providing and disposing the ceramic composition on the substrate 34 to form the ceramic frit layer 44 on the substrate 34 such that the substrate 34 has the ceramic frit layer 44. In certain embodiments, the ceramic composition is disposed at a periphery of the substrate 34 such that the substrate 34 has the ceramic frit layer 44 at the periphery of the substrate 34 to define the daylight opening 32. In other embodiments, the ceramic composition is disposed at the first side 40 of the substrate 34 and at the second side 42 of the substrate 34 such that the substrate 34 has the ceramic frit layer 44 at the first side 40 of the substrate 34 and at the second side 42 of the substrate 34 to define the daylight opening between the first and the second sides 40, 42 of the substrate.

The method further includes the step of providing and disposing a first conductive composition on the substrate 34 to form the first layer 74 of the conductive material of the first busbar 56 and the second busbar 58. In certain embodiments, the gridline portion 60 is disposed on the substrate 34 and formed from the step of disposing the first conductive composition such that the step of providing and disposing the first conductive composition is further defined as the step of providing and disposing the first conductive composition on the substrate 34 to form the first layer 74 of the conductive material of the first busbar 56, the second busbar 58, and the gridline portion 60. In embodiments including the third busbar 62, the step of disposing the first conductive composition on the substrate 34 further forms the first layer 74 of the conductive material of the third busbar 62. In certain embodiments, the step of disposing the ceramic composition is prior to the step of disposing the first conductive composition such that the first conductive composition is disposed on at least the ceramic frit layer 44 of the substrate 34. In certain embodiments, the first conductive composition is further defined as the first silver paste.

The method further includes the step of providing and disposing a second conductive composition on the first layer 74 of the conductive material of at least one of the first busbar 56 and the second busbar 58 to form the second layer 76 of the conductive material of at least one of the first busbar 56 and the second busbar 58. In certain embodiments, the gridline portion 60 is disposed on the substrate 34 and formed from the step of disposing the second conductive composition such that the step of providing and disposing the second conductive composition is further defined as the step of providing and disposing the second conductive composition on the substrate 34 and the first layer 74 of the conductive material of at least one of the first busbar 56 and the second busbar 58 to form the second layer 76 of the conductive material of the gridline portion 60 and at least one of the first busbar 56 and the second busbar 58. In embodiments including the third busbar 62, the step of disposing the second conductive composition on the first layer 74 of the conductive material further forms the second layer 76 of the conductive material of the third busbar 62. In certain embodiments, the step of disposing the ceramic composition is after the step of disposing the second conductive composition such that the ceramic frit layer 44 is disposed on at least the conductive material. In certain embodiments, the second conductive composition is further defined as the second silver paste.

The second conductive composition is either the same as or different than the first conductive composition. In certain embodiments, the first conductive composition is further defined as the first silver paste and the second conductive composition is further defined as the second silver paste. In other embodiments, the first conductive composition and the second conductive composition are further defined as second silver paste.

In certain embodiments, the steps of disposing the first conductive composition and disposing the second conductive composition are further defined as the steps of printing the first conductive composition and printing the second conductive composition.

The method may further include the step of applying heat to the ceramic frit layer 44 prior the step of disposing the first conductive composition on the substrate. In certain embodiments, the step of applying heat is performed with an infrared lamp or conductive heating. The step of applying heat is also referred to as the step of drying. The step of applying heat to the ceramic frit layer 44 is typically carried out at temperatures of from 300 to 450 degrees Fahrenheit. The drying time for the ceramic frit layer 44 is typically between 30 to 90 second.

The method may further include the step of applying heat to the first layer 74 of the conductive material prior to the step of disposing the second conductive composition on the first layer 74 of the conductive material of at least one of the first busbar 56 and the second busbar 58. The step of applying heat to the first layer 74 of the conductive material is typically carried out at temperatures of from 300 to 500 degrees Fahrenheit. The drying time for the first layer 74 of conductive material is typically between 30 and 120 seconds.

The method may further include the step of applying heat to the second layer 76 of the conductive material. The step of applying heat to the second layer 76 of the conductive material is typically carried out at temperatures of from 300 to 500 degrees Fahrenheit. The drying time for the second layer 76 of conductive material is typically between 30 and 120 seconds.

In various embodiments, the steps of drying the ceramic frit layer 44, the first layer 74 of the conductive material, and the second layer 76 of the conductive material minimize the risk of delamination of the conductive material from the substrate 34, the ceramic frit layer 44, or delamination of one layer of the conductive material from another layer of the conductive material.

The method may further include the step of disposing the first mesh screen 78 on the substrate 34 prior the step of disposing the first conductive composition on the substrate 34 such that the step of disposing the first conductive composition on the substrate 34 is further defined as the step of disposing the first conductive composition on the substrate 34, the first mesh screen 78, or a combination thereof.

The method may further include the step of disposing the second mesh screen 80 on the first layer 74 of the conductive material prior the step of disposing the second conductive composition on the first layer 74 of the conductive material such that the step of disposing the second conductive composition on the first layer 74 of the conductive material is further defined as the step of disposing the second conductive composition on the first layer 74 of the conductive material, the second mesh screen 80, or a combination thereof.

Non-limiting examples of several embodiments of the method of forming the window pane 30 are described below. Referring specifically to FIG. 15, in one embodiment of the window pane 30, the method further includes the step of providing and disposing the first silver paste on at least one of the substrate 34 and the ceramic frit layer 44 to form the first layer 74 of the conductive material of each of the gridline portion 60 and the first and the second busbars 56, 58. The method of this embodiment further includes the step of drying the first layer 74. The method of this embodiment further includes the step of providing and disposing the second silver paste on the first layer 74 to form the second layer 76 of the conductive material of at least one of the first and the second busbars 56, 58. The method of this embodiment further includes the step of drying the second layer 76. In this embodiment, the steps of drying are performed with an infrared lamp or conductive heat.

Referring specifically to FIGS. 15 and 24, in another embodiment, the method further includes the step of providing and disposing the first mesh screen 78 on at least one of the substrate 34 and the ceramic frit 20 for at least one of the first and the second busbars 56, 58. The method of this embodiment further includes the step of providing and disposing the first silver paste on at least one of the substrate 34, the ceramic frit layer 44, and the first mesh screen 78 to form the first layer 74 of the conductive material of each of the gridline portion 60 and the first and the second busbars 56, 58. The method of this embodiment further includes the step of drying the first layer 74. The method of this embodiment further includes the step of providing and disposing the second mesh screen 80 on the first layer 74 of the conductive material of at least one of the first and the second busbars 56, 58. The method of this embodiment further includes the step of providing and disposing the second silver paste on at least one of the first layer 74 and the second mesh screen 80 to form the second layer 76 of the conductive material of at least one of the first and the second busbars 56, 58. The method of this embodiment further includes the step of drying the second layer 76. In this embodiment, the steps of drying are performed with an infrared lamp or conductive heat.

Referring specifically to FIG. 14, in another embodiment, the method further includes the step of providing and disposing the second silver paste on at least one of the substrate 34 and the ceramic frit layer 44 to form the first layer 74 of the conductive material of each of the gridline portion 60 and the first and the second busbars 56, 58. The method of this embodiment further includes the step of drying the first layer 74. The method of this embodiment further includes the step of providing and disposing the second silver paste on the first layer 74 to form the second layer 76 of the conductive material of at least one of the first and the second busbars 56, 58. The method of this embodiment further includes the step of drying the second layer 76. In this embodiment, the steps of drying are performed with an infrared lamp or conductive heat.

Referring specifically to FIGS. 14 and 24, in another embodiment, the method further includes the step of providing and disposing the second mesh screen 78 on at least one of the substrate 34 and the ceramic frit layer 44 for at least one of the first and the second busbars 56, 58. The method of this embodiment further includes the step of providing and disposing the second silver paste on at least one of the substrate 34, the ceramic frit layer 44, and the second mesh screen 80 to form the first layer 74 of the conductive material of each of the gridline portion 60 and the first and the second busbars 56, 58. The method of this embodiment further includes the step of drying the first layer 74. The method of this embodiment further includes the step of providing and disposing the second mesh screen 80 on the first layer 74 of the conductive material of at least one of the first and the second busbars 56, 58. The method of this embodiment further includes the step of providing and disposing the second silver paste on at least one of the first layer 74 and the second mesh screen 80 to form the second layer 76 of the conductive material of at least one of the first and the second busbars 56, 58. The method of this embodiment further includes the step of drying the second layer 76. In this embodiment, the steps of drying are performed with an infrared lamp or conductive heat.

It is to be understood that the appended claims are not limited to express and particular compounds, compositions, or methods expressly described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described herein in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described within the scope of the appended claims. The subject matter of all combinations of independent and dependent claims, both single and multiple dependent, is herein expressly contemplated.

What is claimed is:

1. A window pane having a daylight opening, said window pane comprising:
a substrate having a first surface and a second surface opposite said first surface; and
an electrical device comprising a first busbar, a second busbar, and a gridline portion with said first busbar, said second busbar, and said gridline portion in electrical communication with each other and each independently comprising a conductive material;
wherein said first busbar is disposed on said substrate, said second busbar is disposed on said substrate spaced from said first busbar, and said gridline portion has a first end operatively connected to and abutting said first busbar and a second end operatively connected to and abutting said second busbar with a gridline length defined between said first and second ends of said gridline portion and said gridline portion completely and directly disposed on said first surface of said substrate along said gridline length;
wherein said first busbar and said second busbar each independently comprises a first layer of said conductive material disposed on said substrate, and at least one of said first busbar and said second busbar each independently comprises a second layer of said conductive material disposed on said first layer;
wherein said gridline portion comprises one of said first layer of said conductive material or said second layer of said conductive material; and
wherein said conductive material of said first layer and said second layer is either the same or different.

2. The window pane as set forth in claim 1 wherein said substrate has a ceramic frit layer disposed on said first surface of said substrate.

3. The window pane as set forth in claim 2 wherein said ceramic frit layer is disposed at a periphery of said substrate to define the daylight opening.

4. The window pane as set forth in claim 2 wherein said ceramic frit layer is disposed at a first side of said substrate and at a second side of said substrate with the first side opposite said second side to define the daylight opening between said first and said second sides of said substrate.

5. The window pane as set forth in claim 2 wherein said first busbar and said second busbar are disposed on said ceramic frit layer of said substrate and spaced from said substrate.

6. The window pane as set forth in claim 2 wherein said first busbar and said second busbar are disposed between said substrate and said ceramic frit layer of said substrate.

7. The window pane as set forth in claim 1 wherein said gridline portion comprises said first layer of said conductive material.

8. The window pane as set forth in claim 7 wherein said first layer of said conductive material of said first busbar, said second busbar, and said gridline portion is a single and homogenous layer extending along said substrate.

9. The window pane as set forth in claim 1 wherein said gridline portion comprises said second layer of said conductive material.

10. The window pane as set forth in claim 1 wherein said gridline portion comprises two or more heating elements.

11. The window pane as set forth in claim 1 wherein said electrical device further comprises a third busbar disposed on said substrate with said third busbar in electrical communication with said first busbar, said second busbar, and said gridline portion.

12. The window pane as set forth in claim 11 wherein said third busbar comprises said first layer of said conductive material.

13. The window pane as set forth in claim 12 wherein said third busbar further comprises said second layer of said conductive material.

14. The window pane as set forth in claim 1 wherein said conductive material is free of solder between said first layer of said conductive material and said second layer of said conductive material.

15. The window pane as set forth in claim 1 wherein said electrical device is free of a conductive braid.

16. The window pane as set forth in claim 1 wherein said electrical device comprises no more than two solder joints.

17. The window pane as set forth in claim 1 wherein said electrical device is a heating grid.

18. The window pane as set forth in claim 1 wherein said first layer of said conductive material has a resistivity of from 2.4 to 5.1 Ω/ft and said second layer of said conductive material has a resistivity of from 1.0 to 3.9 Ω/ft with said resistivity of said first layer of said conductive material being greater than said resistivity of said second layer of said conductive material.

19. The window pane as set forth in claim 1 wherein said first layer of said conductive material and said second layer of said conductive material each independently has a resistivity of from 1.0 to 3.9 Ω/ft.

20. The window pane as set forth in claim 1 wherein said first layer and said second layer comprise silver as said conductive material.

21. The window pane as set forth in claim 1 wherein said first busbar and said second busbar each independently has a first edge abutting said gridline portion and a second edge opposite said first edge with said first edge and said second edge defining a busbar width between said first edge and said second edge wherein said busbar width of said first busbar and said second busbar is each independently less than 12 millimeters.

22. The window pane as set forth in claim 1 wherein said first layer of said conductive material and said second layer of said conductive material each independently has a dry film thickness of no greater than 20 μm.

23. The window pane as set forth in claim 1 further defined as a sliding panel for a sliding window assembly.

24. A method for forming a window pane having a daylight opening with the window pane comprising an electrical device comprising a first busbar, a second busbar, and a gridline portion with the first busbar, the second busbar, and the gridline portion each independently comprising a conductive material and in electrical communication with each other, said method comprising the steps of:
providing a substrate;
disposing a first conductive composition on the substrate to form a first layer of the conductive material of the first busbar and the second busbar; and
disposing a second conductive composition, which is either the same as or different than the first conductive composition, on the first layer of the conductive material of at least one of the first busbar and the second busbar to form a second layer of the conductive material of at least one of the first busbar and the second busbar;
wherein the gridline portion is disposed on the substrate, and formed from the step of disposing the first conductive composition or from the step of disposing the second conductive composition.

25. The method as set forth in claim 24 wherein the gridline portion has a first end operatively connected to and abutting the first busbar and a second end operatively connected to and abutting the second busbar with a gridline length defined between the first and second ends of the gridline portion, and the gridline portion is completely and directly disposed on the substrate along the gridline length.

26. The method as set forth in claim 24 wherein the steps of disposing the first conductive composition and disposing the second conductive composition are further defined as the steps of printing the first conductive composition and printing the second conductive composition.

27. The method as set forth in claim 24 further comprising the step of disposing a ceramic composition on the substrate to form a ceramic frit layer on the substrate such that the substrate has the ceramic frit layer.

28. The method as set forth in claim 27 wherein the step of disposing the ceramic composition is prior to the step of disposing the first conductive composition such that the first conductive composition is disposed on at least the ceramic frit layer of the substrate.

29. The method as set forth in claim 28 further comprising the step of applying heat to the ceramic frit layer prior to the step of disposing the first conductive composition on the substrate.

30. The method as set forth in claim 27 wherein the step of disposing the ceramic composition is after the step of disposing the second conductive composition such that the ceramic frit layer is disposed on at least the conductive material.

31. The method as set forth in claim 27 wherein the ceramic composition is disposed at a periphery of the substrate such that the substrate has the ceramic frit layer at the periphery of the substrate to define the daylight opening.

32. The method as set forth in claim 27 wherein the ceramic composition is disposed at a first side of the substrate and at a second side of the substrate with the first side opposite the second side such that the substrate has the ceramic frit layer at the first side of the substrate and at the second side of the substrate to define the daylight opening between the first and the second sides of the substrate.

33. The method as set forth in claim 24 wherein the electrical device further comprises a third busbar.

34. The method as set forth in claim 33 wherein the third busbar is formed from the first conductive composition on the substrate.

35. The method as set forth in claim 34 wherein the third busbar is formed from the second conductive composition on the first layer of the conductive material.

36. The method as set forth in claim 24 further comprising the step of applying heat to the first layer of the conductive material prior to the step of disposing the second conductive composition on the first layer of the conductive material.

37. The method as set forth in claim 24 further comprising the step of applying heat to the second layer of the conductive material.

38. The method as set forth in claim 24 wherein the first busbar and the second busbar each independently has a first edge abutting the gridline portion and a second edge opposite the first edge with the first edge and the second edge defining a busbar width between the first edge and the second edge wherein the busbar width of the first busbar and the second busbar is each independently less than 12 millimeters.

39. The method as set forth in claim 24 wherein the first layer of the conductive material and the second layer of the conductive material each independently has a dry film thickness of no greater than 20 μm.
